(19) United States
(12) Patent Application Publication
(10) Pub. No.: US 2008/0135191 A1
(43) Pub. Date: Jun. 12, 2008

(54) LINK SYSTEM FOR SHADE COUPLINGS

(76) Inventor: Joseph W. Zakowski, New Canaan, CT (US)

Correspondence Address: GOTTLIEB RACKMAN & REISMAN PC, 270 MADISON AVENUE, 8TH FLOOR, NEW YORK, NY, 10016-0601, US

(21) Appl. No.: 11/567,468

(22) Filed: Dec. 6, 2006

(51) Int. Cl. E06B 9/24; E06B 3/48

(52) U.S. Cl. 160/181; 160/368.1

(57) ABSTRACT

The present application pertains to a system for adjusting the height of a covering, such as window or a wall covering formed of two or more covering segments that are axially aligned. The system includes a link that prevents the problem of telescoping coverings. The link includes a bracket with a bearing vertically movable within the bracket. A height adjusting member is provided that adjusts or sets the height of the bearing. In this manner a person installing the system can adjust the height of the covering ends insuring that the covering segments are properly aligned and that the coverings are essentially horizontal,

### RELATED APPLICATIONS

None

### BACKGROUND OF THE INVENTION

1. Field of the Invention

The invention relates to the field of window treatments window coverings. More specifically, the invention is a link system for coupling a plurality window coverings together end-to-end and to couple them together so that they can be controlled (e.g., raised and lowered) simultaneously.

2. Description of the Prior Art

In some installations (especially in industrial or commercial environment) it is necessary to provide covering for a very wide window and/or door opening. Since the length of a typical window covering, such as a window shade is somewhat limited, several such coverings must be provided for the opening. Additionally, in some situations there are multiple windows divided by window panes and the application/situation does not permit multiple clutches to be installed. In some instances, individual window coverings may be provided that are disposed side-by-side. However, in many instances it is desirable to have the window coverings connected by couplings that transmit motion axially to raise and lower or the coverings simultaneously.

A major problem with coupled window covering such as shades is telescoping. Telescoping occurs when the window covering fabric rolls up in an uneven manner. Instead of lining up in the same horizontal position, the edges of the window covering shift either to the left or to the right, in other words as the shade covering is rolled up the vertical edge of the material can shift to the left or right. This shift may be insignificant at first, but over time the shift increases and eventually the covering shifts far enough to one side that it interferers with the control mechanisms, and or with an adjacent treatment. Telescoping generally occurs when the window coverings are not horizontal or level from one end to the other.

While some ceilings are constructed with a nominally uniform height, many times, there are minute differences in height from one side of a room to another. This is especially true with windows or ceilings in older buildings. Over time the earth shifts, buildings settle and materials warp. These factors cause a lack of uniformity in the height of the ceiling. When standard window covering mounts are attached to the non-uniform ceiling, the problem of telescoping, as described above occurs when standard mounting hardware is used. Telescoping may also occur if two adjacent window covering segments are not properly aligned with each other.

Some typical coupling systems for window treatments are found in the following patents. WO 2006/042377; U.S. Pat. No. 7,051,782, EP 0863290; DE 19546203; DE 4227425; AU 200189239. However none of the these references solve the problems addressed herein.

### SUMMARY OF THE INVENTION

As described above, telescoping occurs when the covering is rolled up and either of the edges of the covering extends beyond the lateral limits of the shade. Telescoping is most commonly caused when the window covering is installed and is not completely horizontal, or when two adjacent covering segments are not completely aligned with each other. This improper installation is often caused when the window covering is installed upon a ceiling, which is not even or completely horizontal. The present invention aims to solve this problem by providing a link between adjacent coverings with means for adjusting the height of the lateral ends of the coverings.

Generally speaking, the link includes a bracket that mounts to the ceiling (or other stationary surface) and extends downward or extends from the mounting surface. A bearing is then inserted into the bracket. The bearing is held in place by a height adjusting member. In this manner, the bearing is vertically adjustable within the bracket and its position is determined by the height adjusting member.

The height adjusting member preferably includes a clip and a screw that passes through the clip and contacts the bearing. The clip and the bearing are captured by the bracket. Moreover, clip and screw are sized and shaped so that when the screw is engaged by the clip, the clip cannot be removed from the bracket without breaking it. In order to remove the clip from the bracket, the screw must be removed.

Once the bracket is in place and the bearing height is set, the covering segments are aligned properly thereby eliminating telescoping.

### BRIEF DESCRIPTION OF THE FIGURES

To further satisfy the recited objectives, a detailed description of typical embodiments of the invention is provided with reference to appended drawings that are not intended to limit the scope of the invention, in which:

FIG. 1 is a partial perspective view of two window shades connected by a link constructed in accordance with this invention;

FIG. 2 is an exploded view of the link and associated elements of the shades;

FIG. 3 is a perspective view of the link and the elements of FIG. 2;

FIG. 4 is a perspective view of the level clip used in the link of FIGS. 1-3

FIG. 5 is a perspective view of assembled link holding a shaft and a bushing.

### DESCRIPTION OF THE INVENTION

The present invention may be embodied in other specific forms without departing from its spirit or essential characteristics. The described embodiments are to be considered in all respects only as illustrative and not as restrictive. The scope of the invention is, therefore, indicated by the appended claims and their combination in whole or in part rather than by the foregoing description. All changes that come within the meaning and range of equivalency of the claims are to be embraced within their scope.

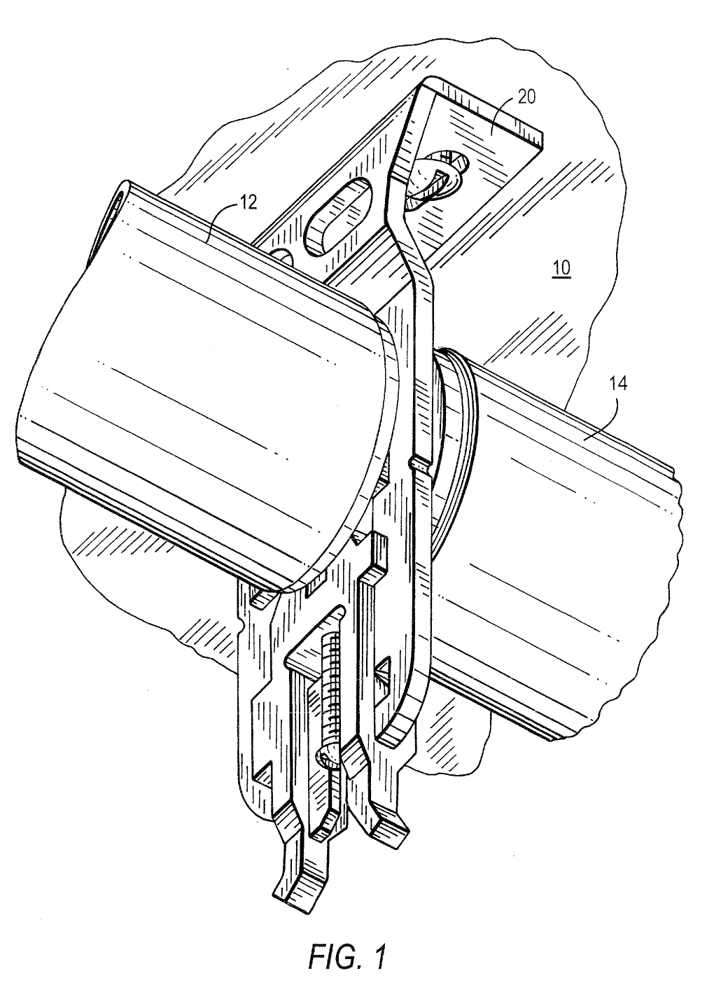

The present invention provides a means for preventing the problem of telescoping in several shades mounted coaxially. More specifically, as shown in FIG. 1, the present invention pertains to a system 10 including two shades 12, 14 coupled by a link 20. For the sake of clarity, only the cylindrical barrels of the shades 12, 14 are shown, it being understood that in a typical system, the shades also include respective sheets that are attached and wound on the barrels. The two shades are aligned coaxially by the link 20 and coupled so when rotation is applied to one of the shades by control means not shown, the coupling transmits this rotation to the other shade. If the common axis of the two shades is not fairly horizontal, as the shades 12, 14 are raised and lowered; their sheets can telescope or migrate unto the barrel of an adjacent shade. Although in the following description a system with two shades is discussed, the invention can be extended to systems with more then two shades by employing an identical link between each shade.

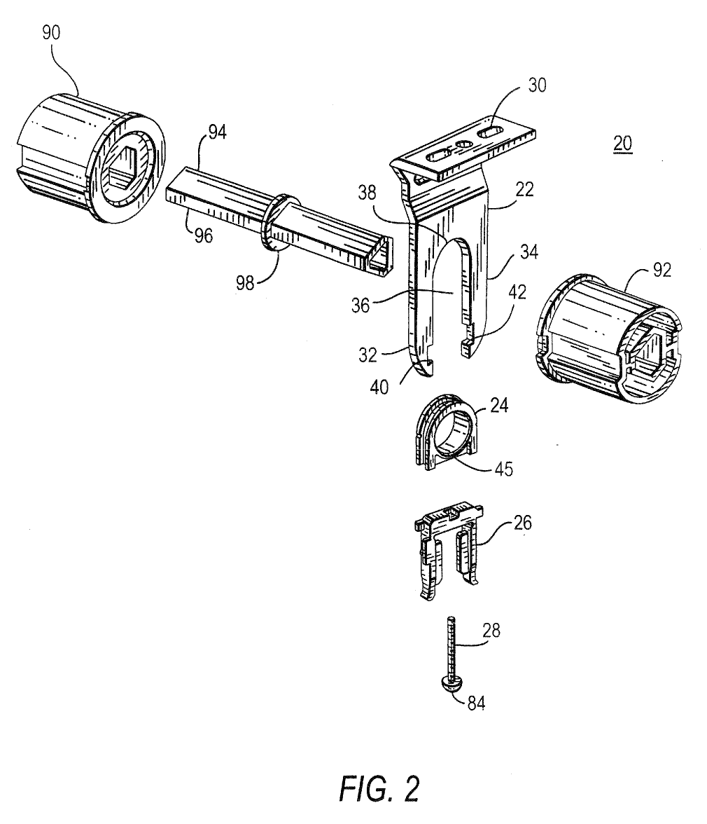

FIG. 2 shows the major parts of the link 20. As can be seen in this Figure, the link 20 includes a bracket 22, a bearing 24 and a clip 26 supported by a screw 28. The bracket 22 is generally L-shaped and it attaches to the ceiling via the holes 30. The bracket 22 further includes two prongs 32, 34 extending downwardly to form an elongated opening 36. A top portion 38 of the opening 36 is semicircular to receive bearing 24. Near their bottom end, the prongs are formed with two horizontal rectangular cut-outs 40, 42.

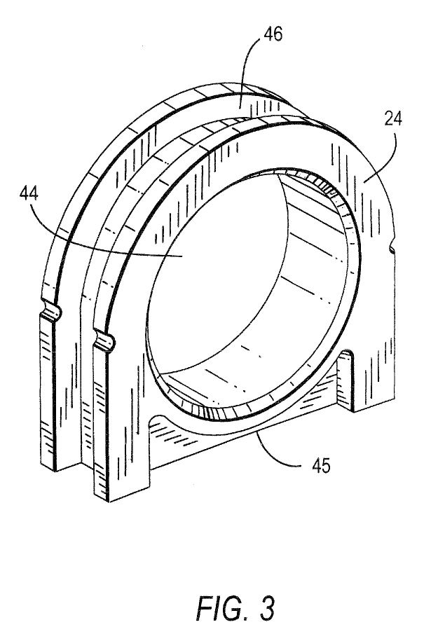

FIG. 3 shows a perspective view of the bearing 24. The bearing is generally D-shaped with a round hole 44 and a circumferential groove 46. The groove 46 is along the top surface and along the two side surfaces of the bearing 24. The width of the groove 46 is equal to or slightly smaller then the thickness of the prongs 32, 34 and the overall width of the bearing 24 is larger then the width of the opening 24 to allow the bearing 24 to slide vertically into the opening 24 until the bearing 24 nestles against the portion 38.

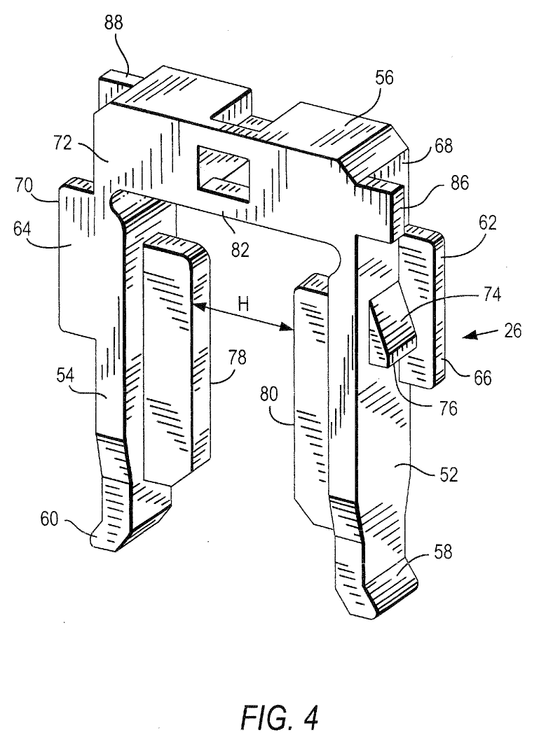

FIG. 4 shows a perspective view of the clip 26. The clip 26 is formed in the shape of an up-side-down “U” with two arms 52, 54 joined by a horizontal bar 56 and terminating with outwardly extending protrusions 58, 60. Each arm 52, 54 is formed with two lips 62, 64 that are thinner then the rest of the clip 26. The lip 62 is formed so that its external surface 66 is flush with the back surface 66 of clip 26 while the lip 64 is formed so that its front surface 70 is flush with the front surface 72 of clip 26. Adjacent to one or both lips 62, 64 there is provided a ramp 74 with a horizontal shoulder 76. The arms 52, 54 are also formed with two ribs 78, 80 extending inwardly as shown. Bar 56 is formed with a threaded hole 82 extending vertically and sized to accept screw 28. The bar 56 also has two external lips 86, 88. Lips 62, 64, 86, 88 cooperate to form vertical channels along the sides the clip 26 sized and shape to receive the two prongs 32, 34. The lips 86, 88 are sized to match the size and spacing of cuts 40, 42.

The screw 28 has a head 84 that has a width approximately equal to the horizontal distance H between the ribs 78, 80.

The clip 26 is sized and shape so that when is inserted into the bracket 22 or mated with it either from the bottom or by partially superimposing the clip 26 over the bracket 22 so that the lips 86, 88 pass through the cuts 40, 42 and then pushing the clip upward, causing the prongs 32, 34 to pass into the channels mentioned above. The two arms 52, 54 are flexible so that as the ramp(s) 74 pass between the ends of the prongs 32, 34 the arms flex slightly toward each other allowing the clip to progress further until the ramp(s) 74 reach the cuts 40, 42. At this point, the arms 52, 54 back and the clip is trapped within the bracket 22 with the shoulder 76 resting on the bottom or horizontal surface of the cuts 40, 42. The clip 26 can be removed by flexing the arms 52, 54 together thereby allowing the clip to be retrieved from between the prongs 32, 34.

The bracket is used as follows. The bearing 24 is first inserted between the two prongs 32, 34 with the prongs 30, 32 being disposed in the groove 46. Next, the clip 22 is inserted therein so that the bearing 24 is held in the bracket 22.

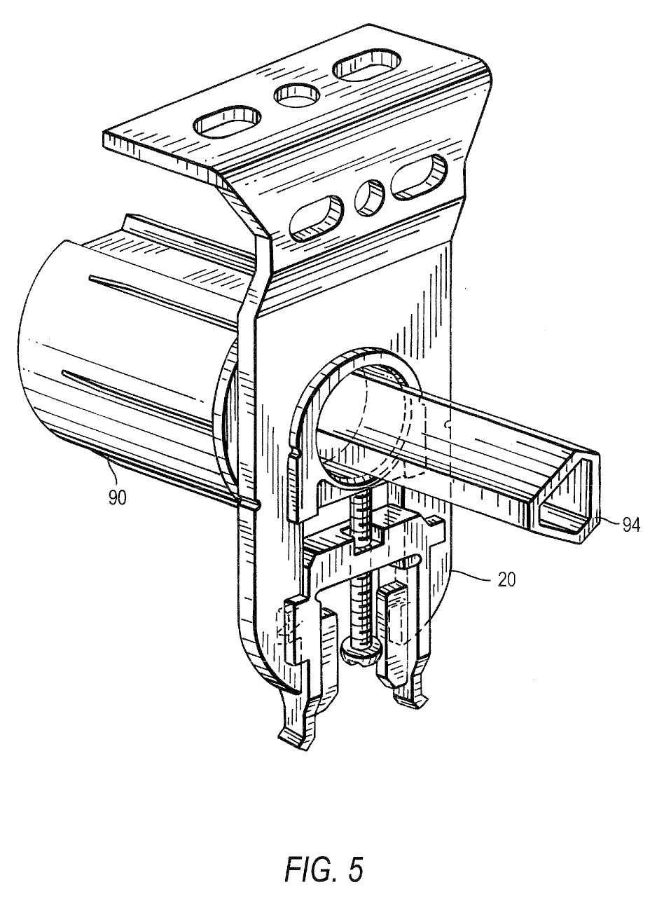

The shades 12, 14 are supported by several brackets. The brackets may have different shapes. As shown in FIG. 1, bracket 22 is used to support the shades on a ceiling or other suitable surface. As shown in FIG. 2, the assembly 10 further includes a first bushing 90, a second bushing 92 and a shaft 94. The bushings are hollow and have a shape that is complementary to the cross-sectional shape of the shaft 94. Preferably, the shaft 94 has a cross-sectional shape that is other then circular so that rotation of one of the bushings, e.g. bushing 90 is easily transmitted by the shaft 94 to the other bushing 92. In the FIG. 5 the shaft is triangular. Of course, many other shapes or means well know in the art may be used to insure that rotation is readily transmitted between the bushings, and that the housings are coupled and driven simultaneously. The bushings are inserted are housed in the mandrels of shades 12, 14 using frictional engagement or any other well known means.

Shaft 94 has, at least in one end, a flexible tong 96 or other means sized and shaped so that once the shaft 94 is inserted into the bushing 90 the two elements are interlocked, permanently, or temporarily. The shaft 94 may also include a flange 98 that acts as a stop.

The shades 12, 14 are installed in the conventional manner, with the shaft 94 being inserted into the bushings and also being supported by the link 20. More particularly, the ends of the shaft are disposed in the bushings 90, 92 while its mid section passes through hole 44 of bearing 24 and is supported by the link 20. At this stage, the shaft 94, the bearing 22 and the clip 24 are movable vertically between the prongs 32, 34.

Next, the screw 28 is inserted between the arms 32, 34 and is rotated clockwise so that its tip is engaged by hole 82. The screw 28 is then rotated by a screw driver or other known means causing it to advance vertically upward through the clip 26 thereby coming into contact with the bottom wall 45 of bearing 24. Advancing the screw 28 further causes the bearing 24 to rise. In this manner the position of the bearing 24 can be adjusted until the shades 12, 14 are properly aligned with each other and are disposed in a substantial horizontal position.

Because the width of the screw head 84 matches the distance between arms 40, 42, the head 84 prevents the arms 40, 42 from flexing thereby effectively entrapping the clip 24 within the prongs 30, 32. The assembled link 20 with shaft 94 and bushing 90 are shown in FIG. 5

Obviously numerous modifications can be made to the invention without departing from its scope as defined in the appended claims. Moreover, it should be understood that while in the preferred embodiment, the invention was described in conjunction with a window covering; it is equally applicable with other different types of apparatus for covering wall, openings, and so on.

I claim:

1. A link for coupling two coverings connected by a shaft comprising:
a bracket having an upper end adapted to secure the bracket;
a bearing vertically movable within said bracket and receiving said shaft; and
a height adjusting member secured to said bracket and arranged to adjust the height of said bearing within said bracket.

2. The link of claim 1 wherein said bracket has two prongs forming an opening and said bearing is positioned and captured within said opening.

3. The link of claim 1 wherein said height adjusting member is mounted in said opening.

4. The link of claim 3 wherein said height adjusting member is disposed below said bearing.

5. The link of claim 3 wherein said height adjusting member includes clip with a threaded hole and a screw selectively passing through said threaded hole to adjust the vertical position of said bearing.

6. A link for coupling two coverings having ends, said link comprising:
a bracket having a U-shaped body with two prongs and a mounting member for mounting said bracket;
a bearing slidably supported between said two prongs and having an opening;
a shaft passing said through said opening and engaging said ends; and
a height adjusting member attached to said bracket and arranged to adjust the position of said bearing within said bracket.

7. The link of claim 6 wherein said bearing has a peripheral groove receiving said two prongs.

8. The link of claim 6 wherein said bearing has a D-shaped cross section with a bottom member contacting said height adjusting member.

9. The link of claim 6 wherein said height adjusting member includes a clip.

10. The link of claim 9 wherein said clip includes a horizontal member and two downwardly extending arms engaging said prongs.

11. The link of claim 9 wherein said clip is formed with two channels receiving said prongs.

12. The link of claim 9 wherein said height adjusting member includes a screw adjustable with respect to said clip, and contacting said bearing to adjust the height of said bearing.

13. A covering system comprising:
a plurality of covering segments, each segment having ends;
a shaft connecting ends of two adjacent segments and cooperating to align said segments and transmit rotation form one segment to another; and
link mounted on a stationary member and including a bracket, a bearing movably attached to said bracket and receiving said shaft and a height adjusting member mounted on said bracket and arranged to adjust the height of said bearing within said bracket.

14. The covering system of claim 13 wherein said bracket is U-shaped with two prongs extending downwardly to receive said bearing and said height adjusting member.

15. The covering system of claim 14 wherein said bearing is captured between said prongs.

16. The covering system of claim 13 wherein said height adjusting member is captured between said prongs.

17. The covering system of claim 13 wherein said height adjusting member includes clip engaging said prongs and a screw rotatably engaging said clip.
